(19) United States
(12) Patent Application Publication
(10) Pub. No.: US 2010/0154219 A1
(43) Pub. Date: Jun. 24, 2010

(54) Package Opener System

(76) Inventor: James C. Huett, Fort Collins, CO (US)

Correspondence Address: CR MILES, P.C.;CRAIG R. MILES, 405 MASON COURT, SUITE 119, FORT COLLINS, CO, 80524, US

(21) Appl. No.: 12/655,009

(22) Filed: Dec. 21, 2009

Related U.S. Application Data
(60) Provisional application No. 61/203,541, filed on Dec. 23, 2008.

(51) Int. Cl. B67B 7/00; B65B 43/26; B23P 17/00

(52) U.S. Cl. 30/2; 53/492; 29/592

(57) ABSTRACT

Generally, a box opener system which provides in a single device a configuration to generate the open condition of numerous and varied types of boxes. Specifically, a cutter element in a handle disposed between a blade element and an impact element which can be used to disengage the sealed outer flaps or the side wall between perforations or cut box liners to generate the open condition of a box.

This United States patent application claims the benefit of U.S. Provisional Patent Application No. 61/203,541, filed Dec. 23, 2008, hereby incorporated by reference herein.

### I. BACKGROUND

Generally, a box opener system which provides in a single device a configuration to generate the open condition of numerous and varied types of boxes. Specifically, a cutter element in a handle disposed between a blade element and an impact element which can be used to disengage the sealed outer flaps or the side wall between perforations or cut box liners to generate the open condition of a box.

A significant problem with opening conventional boxes can be that the manner of sealing and lining the box can require use of a plurality of devices to unseal the outer flaps or tear the box between perforations or generate an opening in the box liner (or all in various permutations and combinations) to allow ingress to the packaged materials or egress of the packaged materials from the box.

Another significant problem with opening of conventional boxes can be that the plurality of devices used to unseal the outer flaps or tear the box between perforations or generate an opening in the box liner can include edges sufficiently sharp to impale or cut the skin or tissue of the user.

Another significant problem with opening of conventional boxes can be that materials used to construct the box and the box liner can be resistant to convention methods used to open boxes. For example, certain box liners may not be opened by conventional grippable engagement and tearing movement of the hands because the materials used in box liners are purposefully made to be tear resistant and may have a surface which does not afford sufficient grip to use a tearing movement sufficiently forceful to tear the liner material. Also, box liners may be fixedly engaged to the side walls of the box and further sealed in a fashion which obstructs use of conventional cutting tools such as scissors. As yet another example, the materials used in the side walls of boxes are often readily impaled but resist tearing between perforations. As yet another example, the outer flaps of boxes may be sealed with a layer of adhesive which does not readily cut but must be separated by wedged or levered engagement.

The invention described herein addresses the problems associated with conventional apparatuses and methods for box opening.

### II. SUMMARY OF THE INVENTION

Accordingly, a broad object of the invention can be to provide in a single device a box opener system configured to generate the open condition of numerous and varied types of boxes.

Another broad object of the invention can be to provide a cutter to cut cuttable materials, a blade having a taper sufficient to disengage sealed outer flaps and an impact element configured to tear the box wall between perforations without also affording cutting, blade, or impact surfaces which can impale or cut the user during normal use to open boxes.

Another broad object of the invention can be to provide a cutter, a blade and an impact element configured to act more effectively upon the materials and liners from which boxes are made to produce the open condition of the box.

Naturally, further objects of the invention are disclosed throughout other areas of the specification, drawings, photographs, and claims.

### III. A BRIEF DESCRIPTION OF THE DRAWINGS

FIG. 1 is an illustration of how to use a particular embodiment of the invention to open the sealed outer flaps of a box.

FIG. 2 is an illustration of how to use a particular embodiment of the invention to open a box liner.

FIG. 3 is an illustration of how to use a particular embodiment of the invention to tear the side wall of a box between a plurality of perforations.

FIG. 4 is a first side view of a particular embodiment of the invention.

FIG. 5 is a top view of a particular embodiment of the invention.

FIG. 6 is a second side view of a particular embodiment of the invention.

FIG. 7 is a first end view of a particular embodiment of the invention.

FIG. 8 is a second end view of a particular embodiment of the invention.

FIG. 9 is a bottom view of a particular embodiment of the invention.

### IV. DETAILED DESCRIPTION OF THE PREFERRED EMBODIMENTS

Generally, a box opener system which provides in a single device a configuration to generate the open condition of numerous and varied types of boxes. Specifically, a cutter element in a handle disposed between a blade element and an impact element which can be used to disengage the sealed outer flaps or the side wall between perforations or cut box liners to generate the open condition of a box.

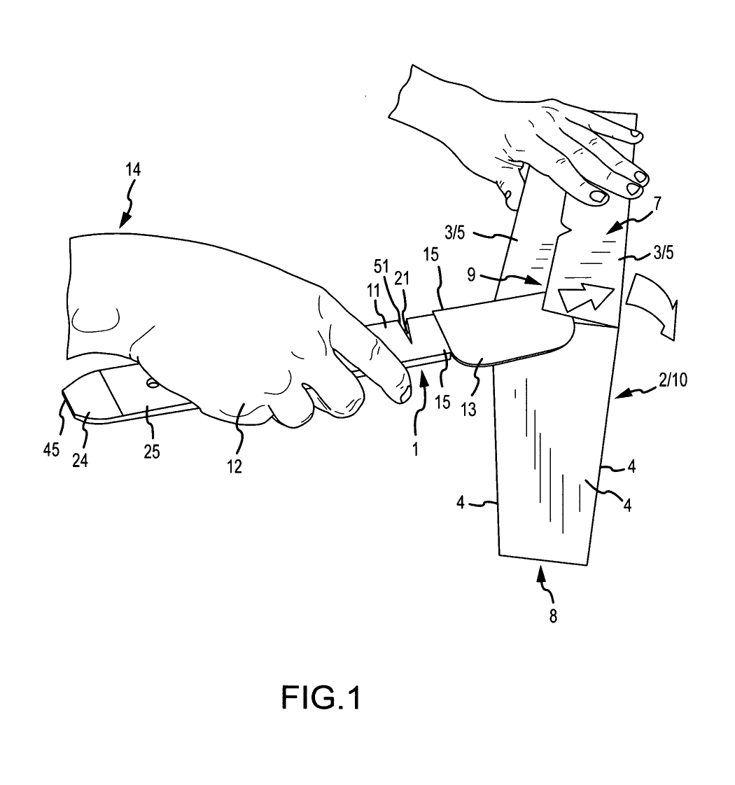

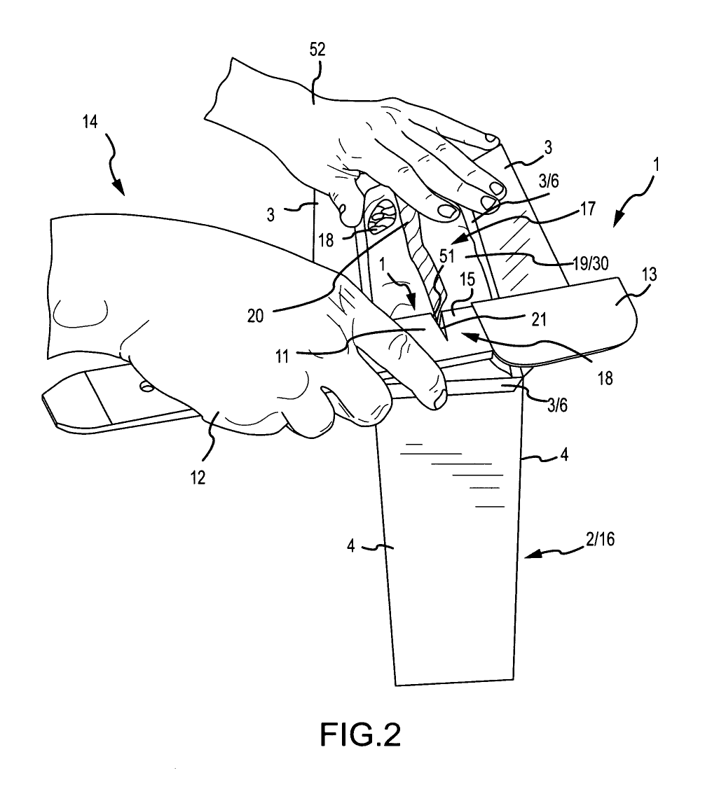

Now referring primarily to FIGS. 1 and 2, a particular method of using the box opener system (1) is shown. A conventional box (2) can provide four flaps (3) one extending from each of four side walls (4) or one extending from each end of each of four side walls (4). The outer flaps (5) sealably overlie the inner flaps (6) to provide a box top (7) and a box bottom (8). A seal (9) between the outer flaps (5) can be provided by encircling the box (2) with a band, applying tape, staples, or a layer of adhesive to the overlappingly engaged surfaces, or the like, to generate the closed condition (10) of the box (2) as shown in FIG. 1. The particular construction of a box (2) above-described is not intended to be limiting with respect to the numerous and wide variety constructional forms of a box (2) which can be opened utilizing the box opener system (1). A box (2) can have any number of side walls (4) such as three, four, five, six, or more side walls (4) all or some of which may provide a corresponding flaps (3) which can sealably overlie to provide the closed condition (10) of the box (2).

Again referring primarily to FIGS. 1 and 2, an embodiment of the box opener system (1) can provide an elongate member (11) (also referred to as “a handle”) a portion of the external surface configured to be grippably engaged or received in a first hand (12) of a user (14) (also referred to as “a person”). In those instances, in which the overlapped portions of outer flaps (5) of the box (2) have a seal (9) in the form of a layer of adhesive, staples, tape, or a combination of these seal materials, a blade (13) extending axially outward from a first handle end (15) can be forcibly urged between the sealably engaged outer flaps (5) (or sealably engaged inner flaps (6) or both) of the box (2). The blade (13) can be drawn between the sealed outer flaps (5) of the box (2) a distance sufficient to disengage the sealed outer flaps (5) to generate the open condition (16) of the box (2) as shown in FIG. 2.

Now referring primarily to FIG. 2, a box (2) can further provide a box liner (17) configured to enclosed an amount of packaged material (18). One non-limiting example of a box liner (17) provides a flexible liner wall (19) in the form of a conduit having length deposed between a pair of sealed liner ends (20). One of the pair of sealed liner ends (20) can have a location proximate the sealed outer flaps (5) in the closed condition (10) of the box (2). Upon disengaging the sealed outer flaps (5), a corresponding one of the pair of sealed liner ends (20) can be gripped by a second hand (52) of a user (14). The box opener system (1) can further provide a cutter element (21) disposed in the handle (11) of the box opener system (1) which can be engaged with the box liner (17) at location below one of the pair of sealed liner ends (20). The cutter element (21) can be forcibly urged against the box liner (17) to excise a portion of or all of the engaged one of the pair of sealed liner ends (20) to provide access to the amount of packaged material (18) inside of the box liner (17). In those embodiments of the box (2) which seal the overlapped outer flaps (5) with a flexible band, the cutter element (21) can be cuttingly engaged with the flexible band to disengage the outer flaps (5) to produce the open condition (16) of the box (2).

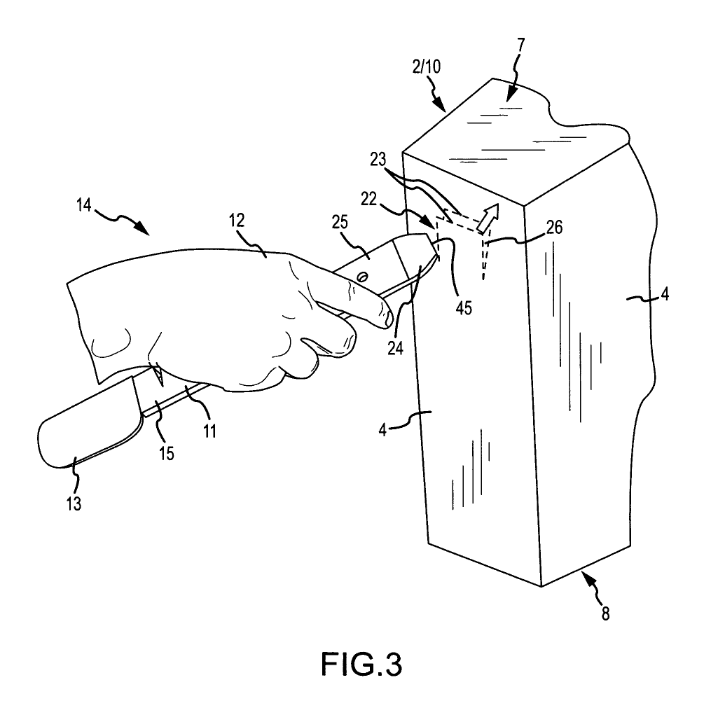

Now referring primarily to FIG. 3, another type of conventional box (2) includes a perforated seal (22) which provides a plurality of perforations (23) between the external surface and the internal surface of one or more side walls (4) of the box (2) (or sufficiently through one of the side walls (4) to allow tearing between partial perforations). Forcible urging or impact proximate the plurality of perforations (23) allows the corresponding one of the side walls (4) of the box (2) to tear between some or all of the plurality of perforations (23) to allow ingress to the interior of the box (2) or egress of the packaged material (18) from the box (2). An impact element (24) extending axially outward from a second handle end (25) can be forcibly engaged to one of the side walls (4) of the box (2) proximate the perforated seal (22)) to tear the box (2) between some or all of the plurality of perforations (23) to generate an access opening (26) in the engaged one of the side walls (4) of the box (2) to allow ingress to the interior of the box (2) or to all egress of the packaged material (18) from the box (2).

By utilizing one or more of the methods or steps above-described in various permutations and combinations with an embodiment of the box opener system (1) further described below a numerous and wide variety of boxes (2) can be opened without having to use a plurality of conventional devices.

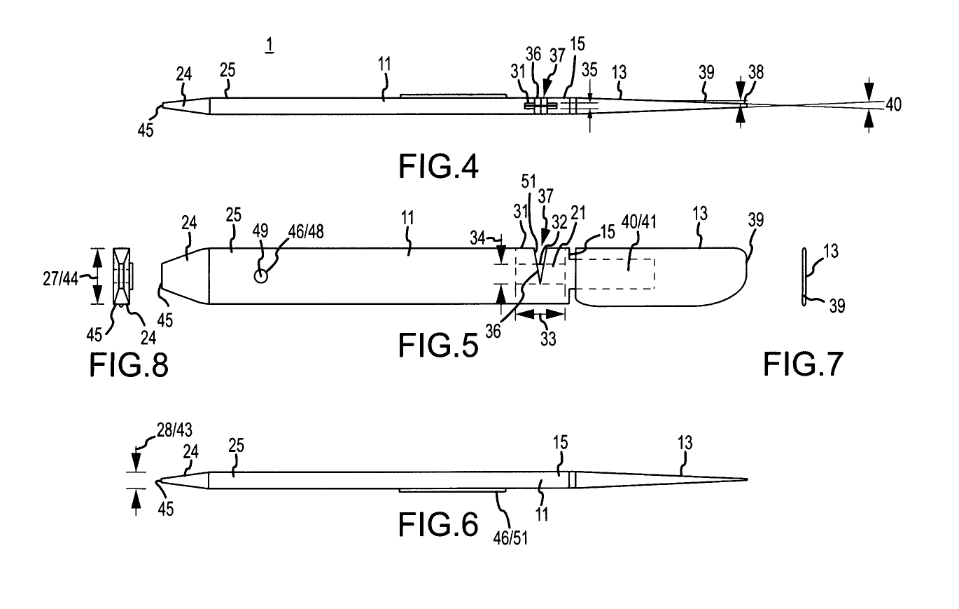

Now referring primarily to FIGS. 4-9, embodiments of the box opener system (1) can include a handle (11) configured to be grippably received by the first hand (12) of a user (14). As shown by FIGS. 4, 5 and 9, the handle (11) can be configured as a rectangular elongate member having a handle width (27) in the range of about three-quarters inch and about one and one-half inch and a handle height (28) in the range of about one-eighth inch and about three-quarters inch. However, the dimensional relations of the handle (11) could be of a lesser or greater range or have any manner of configuration for example oval, square, triangular, round, or other configuration so long as a portion of the handle (11) can be received and sufficiently gripped by the first hand (12) of a user (14) to be used in accordance with the methods above-described.

Again referring primarily to FIGS. 4, 5, and 9, embodiments of the box opener system (1) can further include a cutter element (21) coupled to the handle (11). The cutter element (20) will typically be coupled to the handle (11) proximate to the first handle end (15) or the second handle end (25) or at least sufficiently close to the first handle end (15) or the second handle end (25) such that the handle (11) can be grippingly received by the first hand (12) of a user (14) with the cutter element (21) located a sufficient distance outward from the first hand (12) to engage a cuttable material (30) such as a band which seals the outer flaps (5) of a box (2), a box liner (17), or the like. The cutter element (21) can be coupled to the handle (11) by way of mechanical fasteners such as rivets, spirally threaded screws, adhesive, or can be slidably inserted in a cutter receiving element (31) of the handle (11), or can be coupled to the handle (11) by location in a mold which receives an amount of handle material which cures about the cutter element (21) to fixedly couple the cutter element (21) to the handle (11). The cutter element (21) can further include a cutter edge (32) capable of cutting a cuttable material (30) of a box (2).

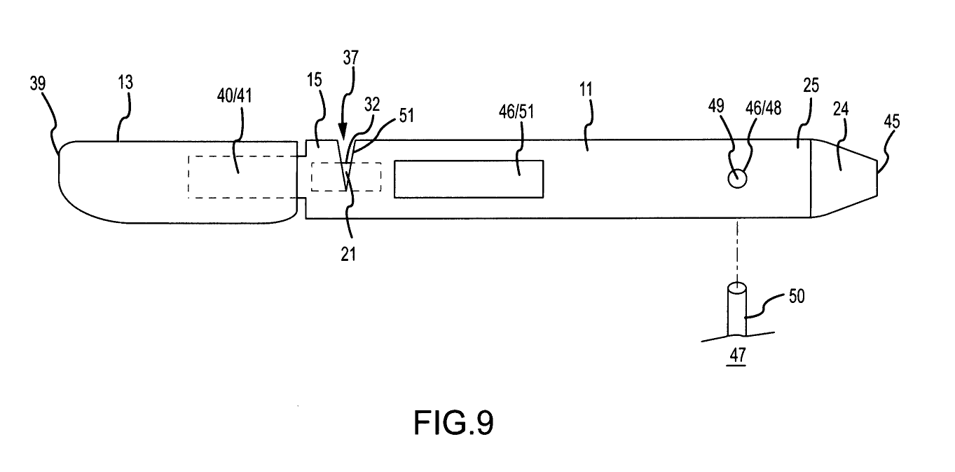

The non-limiting embodiment of the handle (11) shown in FIG. 5, provides a cutter receiving element (31) configured to receive a part of the cutter element (21). The cutter element (21) shown in the non-limiting example of FIG. 5 has a substantially flat rectangular configuration having a cutter length (33) in the range of about one-half inch to about one inch and a cutter width (34) in the range of about one eighth and about one-half inch with a cutter thickness (35) in the range of one-thirty second of an inch and about one-sixteenth of an inch. The cutter receiving element (31) can be correspondingly configured as a slot having a slot length, a slot width and a slot depth which allows the substantially flat rectangular configuration of the cutter element (21) above-described to insertingly engage the handle (11). The cutter receiving element (31) can be configured to sufficiently engage the cutter element (21) upon insertion to retain the cutter element (21) in the cutter receiving element (31) of the handle (11) during normal use. Certain embodiments of the cutter receiving element (31) can have sufficient depth to allow the cutter edge (32) of the cutter element (31) to be recessed a distance below the external surface of the handle (11), as shown in the non-limiting example of FIGS. 5 and 9. In those embodiments of the handle (11) in which the cutter element (21) has been recessed a distance below the external surface of the handle (11), the handle (11) further provides an indentation element (36) which provides an cutter open space (37) in which a part or all of the cutter edge (32) of the cutter element (31) can be sufficiently exposed to allow engagement of a cuttable material (30) with the cutter edge (32). The indentation element (36) of the handle (11) can be configured to provide a cutter open space (37) which at the external surface of the handle (11) has greater width than at the cutter edge (32) to provide a cutter open space (37) which narrows approaching the cutter edge (32) but has sufficient width at the cutter edge (32) to allow cutting engagement of a cuttable material (30) with the cutter edge (32). The configuration of the cutter element (21) is not limited to a flat rectangular configuration shown in the Figures and can be any configuration which can be coupled to the handle (11) and provides a cutter edge (32) useful in cutting cuttable material (30) of a box (2). While the cutter open space (37) shown in FIG. 5 has a triangular or truncated triangular boundary, the invention is not so limited and the cutter open space (37) can provide a cuttable material guide (51) having surfaces with define a triangular boundary, a rectangular boundary, a circular boundary, an oval boundary, or other boundary configuration which correspondingly defines the cutter open space (37) in which cuttable material (30) of a box (2) or a box liner (17) or band which encircles a box (2) are locatable to be engaged with the cutter edge (32).

Again referring primarily to FIGS. 4-9, embodiments of the box opener system (1) can further include a blade (13) extending axially outward from a first handle end (15) (also referred to as the “first elongate member end”). Embodiments of the blade (13) can have a blade thickness (38) greater proximate the first handle end (15) than at the blade terminal (39), as shown for example in FIG. 7. The thickness at the blade terminal (39) can be sufficiently thin to be inserted by forcible urging between the overlapped outer flaps (5) of a box (2) a sufficient distance to disengage the sealed outer flaps (5) to allow the open condition (16) of the box (2). As one non-limiting example, the embodiment of the blade (13) shown in FIG. 5, has a blade thickness (38) in the range of about three sixteenths inch and one eighth inch proximate the first handle end (15) and a thickness in the range of about one-thirty second inch and about one-sixteenth inch at the blade terminal (39). The taper of the blade (13) extending from the blade terminal (39) toward the first handle end (15) provides a blade angle (40) in the range of about five degrees and about ten degrees as shown in FIG. 4. The blade terminal (39) can be sufficiently hebetated to avoid impalement or cutting of the skin or tissue of the user (14) during normal use in opening a box (2). Embodiments of the blade (13) can have a length of in the range of about one inch and about three inches and a width of about one-half to about one and one half inches. The blade (13) can be coupled to the first handle end (15) by use of mechanical hardware such as rivets or spirally threaded screws, adhesive, a tenon (40) insertably engaged in a socket (41) as shown in FIG. 5, or the like. The handle (11) and blade (15) can also be fabricated, molded or otherwise produced as one piece.

Again referring primarily to FIGS. 4-9, embodiments of the box opener system (1) can further include an impact element (24) extending axially outward from a second handle end (25) (also referred to as the “second elongate member end”), as shown for example in FIGS. 5 and 8. Embodiments of the impact element (24) can have an impact element thickness (43) and an impact element width (44) greater proximate the second handle end (25) than at the impact element terminal (45), as shown for example in FIG. 8. The thickness and width of the impact element (24) at the impact element terminal (45) can be sufficient thin and narrow that upon forcible impact with the plurality of perforations (23) between the external surface and the internal surface of the side walls (4) of a box (2), the corresponding one of the side walls (4) of the box (2) will tear between some or all of the plurality of perforations (23) to allow ingress to the interior of the box (2) or egress of the packaged material (18) from the box (2). However, the thickness and width of the impact element (24) at the impact element terminal (45) can be adjusted in relation to the type of material used in the side walls (4) of the box (2) and the manner of providing the plurality of perforations (23) in the material used in the side walls (4) of the box (2) to avoid interpenetration of the corresponding one of the side walls (4) of the box (2) having the perforated seal (22) by other than tearing of the corresponding one of the side walls (4) of the box (2) between a part of the plurality of perforations (23). The impact element terminal (45) can be of any configuration which in normal use achieves tearing of the perforated seal (22) between a part of the plurality of perforations (23) and the particular embodiment of the impact element (24) shown in FIGS. 4-9 is not intended to be limiting with respect to the numerous and varied configurations of the impact element (24) which can be used in the box opener system (1).

Now referring primarily to FIGS. 5 and 9, the box opener system (1) can further include a hang element (46) which functions to allow the box opener system (1) to be located in relation to a certain support surface (47). As shown as a non-limiting example, the box opener system (1) can further include a hang element (46) in the form of an aperture element (48) which provides an aperture (49) which communicates between opposed external surfaces of the handle (11). An elongate member (50) projecting outwardly from a support surface (47) can pass through the aperture (49) to allow hanging securement of the box opener system (1). Another non-limiting example of a hang element (46) can provide a magnet (51) coupled to the external surface of the box opener system which allows magnetic securement of the box opener system (1) with certain types of the support surface (47).

As can be easily understood from the foregoing, the basic concepts of the present invention may be embodied in a variety of ways. The invention involves numerous and varied embodiments of a box opener and a correspondingly numerous and varied methods of opening boxes.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of “box opener” should be understood to encompass disclosure of the act of “opening a box”—whether explicitly discussed or not—and, conversely, were there effectively disclosure of the act of “opening a box”, such a disclosure should be understood to encompass disclosure of “a box opener” and even a “means for opening a box.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

For the purposes of the present invention, ranges may be expressed herein as from “about” one particular value to “about” another particular value. When such a range is expressed, another embodiment includes from the one particular value to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Moreover, for the purposes of the present invention, the term “a” or “an” entity refers to one or more of that entity; for example, “a member” refers to one or more member(s) or at least one member. As such, the terms “a” or “an”, “one or more” and “at least one” can be used interchangeably herein.

For the purpose of the present invention, certain terms relating the parts of human body may be used in the claims for the purposes of further limiting or clarifying the structure of configuration of certain elements. Such use is not intended to claim a human or any part of a human.

Thus, the applicant(s) should be understood to claim at least: i) a box opener as herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A box opener, comprising:
a) an elongate member having a length disposed between a first elongate member end and as second elongate member end, said elongate member having an external surface a portion of which has a configuration for grippable engagement by a hand of a person;
b) a blade element connected to said first elongate member end, said blade element configured to slidingly engage between the sealed outer flaps of a box;
c) an impact element connected to said second elongate member end, said impact element configured to generate upon forcible engagement with a side wall of said box an opening for egress of packaged material within said box; and
d) a cutter element connected to said elongate member outside of said portion of said external surface configured for grippable engagement by said hand of said person, said cutter element having a cutter edge configured to cut a cuttable material located in relation to said external surface of said elongate member to allow engagement with said cuttable material.

2. The box opener of claim 1, further comprising a cutter receiving element configured to receive said cutter element with said cutter edge located in relation to said elongate member to allow engagement of with said cuttable material.

3. The box opener of claim 1, wherein said cutter receiving element has a configuration which locates said cutter edge of said cutter element at a location below said external surface of said elongate member, and wherein said cutter receiving element further includes an indentation element which recesses a portion of said external surface of said elongate member a sufficient depth about said cutter element received in said cutter receiving element to sufficiently expose a portion of said cutter edge to allow engagement of said cutter edge with said cuttable material.

4. The box opener of claim 2, wherein said indentation element further comprises a cuttable material guide configured to provide at said external surface of said elongate member an open space of greater dimension than at said cutter edge at said location below said external surface of said elongate member.

5. The box opener of claim 2, wherein said cuttable material guide has tapered sides which angle sufficiently toward one another approaching said cutter edge of said cutter element to prevent engagement of a part of said person with said portion of said cutter edge exposed to allow engagement of said cutter edge with said cuttable material.

6. The box opener of claim 2, wherein said elongate member has a rectangular configuration having a pair of sides disposed in opposed relation a width apart and a pair of faces disposed in opposed relation a height apart, and wherein said cutter receiving element comprises a slot on one of said pair of sides configured to insertingly receive a cutter element of substantially planar rectangular configuration with said cutter edge located below said external surface of said rectangular elongate member, and wherein said indentation element has a triangular configuration which communicates between said pair of faces to provide said taper sides which angle sufficiently toward one another approaching said cutter edge of said cutter element to prevent engagement of a part of said person with said portion of said cutter edge exposed to allow engagement of said cutter edge with said cuttable material.

7. The box opener of claim 2, wherein said impact element extends outwardly from said second elongate member end of said elongate member to terminate in an impact element terminal of sufficiently lesser dimension than said elongate member to generate upon forcible engagement with a side wall of said box an opening of sufficient dimension for egress of packaged material from within said box.

8. A method of opening a box utilizing the box opener of claim 1, comprising the steps of:
a) gripping in a first hand of a person a portion of an elongate member having a length disposed between a first elongate member end and a second elongate member end; and
i) inserting a blade element connected to said first elongate member end between the sealed outer flaps of a box; and
ii) drawing said blade between said sealed outer flaps a distance sufficient to disengage said sealed outer flaps from one another; or
iii) forcibly engaging an impact element connected to said second elongate member end with a side wall of said box; and
iv) generating an opening in said side wall of said box of sufficient dimension to allow egress of packaged material from within said box.

9. The method of opening a box of claim 8, further comprising the steps of:
a) gripping a portion of a box liner with a second hand of said person;
b) cuttably engaging a cutter edge of a cutter element coupled to said elongate member outside of the portion of said elongate member gripped by said first hand to said box liner; and
c) excising a portion of said box liner sufficient to allow access to packaged material within said box liner.

10. The method of opening a box of claim 9, further comprising the step of inserting said box liner within an indentation element which recesses the external surface of said elongate member sufficiently to expose said cutter edge allowing cuttable engagement with said box liner.

11. The method of opening a box of claim 10, further comprising the step of guiding said box liner toward said cutter edge by slidable engagement of said box liner with a cuttable material guide configured to provide an open space at the level of said external surface of said elongate member of greater dimension than at the level of said cutter edge having a location below said external surface of said elongate member.

12. A method of producing a box opener of claim 1, comprising the steps of:
a) providing an elongate member having a length disposed between a first elongate member end and a second elongate member including a portion configured for grippable engagement by a hand of a person;
b) connecting a blade element to said a first elongate member end, said blade element configured to slidingly engage between the sealed outer flaps of a box;
c) connecting an impact element to a second elongate member end, said impact element configured to generate upon forcible engagement with a side wall of said box an opening for egress of packaged material within said box; and
d) a cutter element connected to said elongate member outside of said portion configured for grippable engagement by said hand of a person, said cutter element having a cutter edge configured to cut a cuttable material, said cutter element located in relation to an external surface of said elongate member to allow engagement of said cutter edge with said cuttable material.

13. The method of producing a box opener of claim 12, further comprising the steps of:
a) coupling a cutter receiving element to said elongate member; and
b) receiving said cutter element within said cutter receiving element which locates said cutter edge at a location in relation to said elongate member which allows engagement of said cutter edge with said cuttable material.

14. The method of producing a box opener of claim 13, further comprising the steps of:
a) configuring said cutter receiving element to locate said cutter edge below said external surface of said elongate member; and
b) coupling an indentation element to said cutter receiving element which recesses a portion of said external surface of said elongate member a sufficient depth about said cutter element in said cutter receiving element to expose a portion of said cutter edge sufficient to allow engagement of said cutter edge with said cuttable material.

15. The method of producing a box opener of claim 14, further comprising the step of:
coupling a cuttable material guide to said indentation element to provide an open space at said external surface of said elongate member of greater dimension than at said cutter edge having a location below said external surface of said elongate member.

16. The method of producing a box opener of claim 15, further comprising the step of configuring said cuttable material guide with tapered sides which angle sufficiently inward approaching said cutter edge of said cutter element to prevent engagement of a part of said person with said cutter edge.

17. The method of producing a box opener of claim 16, further comprising the steps of:
a) providing said elongate member in a generally rectangular configuration having a pair of sides disposed in opposed relation a width apart and a pair of faces disposed in opposed relation a height apart;
b) configuring said cutter receiving element as a slot having a location on one of said pair of sides of said elongate member of rectangular configuration, wherein said slot insertingly receives a cutter element of generally planar rectangular configuration with said cutter edge located below said external surface of said elongate member;
c) providing said indentation element in a triangular configuration which communicates between said pair of faces with said tapered sides which angle sufficiently inward approaching said cutter edge to expose a portion of said cutter edge sufficient to allow engagement with said cuttable material while insufficent to allow engagement with said part of said person.
